(19) United States
(12) Patent Application Publication
(10) Pub. No.: US 2010/0036738 A1
(43) Pub. Date: Feb. 11, 2010

(54) System and Method for Advertising Goods and Services in Print Media

(76) Inventor: John J. Dowd, Virginia Beach, VA (US)

Correspondence Address: WILLIAMS MULLEN, 222 CENTRAL PARK AVENUE, SUITE 1700, VIRGINIA BEACH, VA, 23462, US

(21) Appl. No.: 12/538,355

(22) Filed: Aug. 10, 2009

Related U.S. Application Data
(60) Provisional application No. 61/188,639, filed on Aug. 11, 2008.

(51) Int. Cl. G06Q 30/00

(52) U.S. Cl. 705/14.61; 705/14.66

(57) ABSTRACT

This disclosure describes a hyper-targeted print media advertising system and method that utilizes a relatively new printing technology known as variable data presses. The systems and methods described herein utilize an on-line self-service platform that allows advertisers to design, target, schedule and pay for advertisements in print media (e.g., newspapers) allowing the print media to service handle a far larger number of advertisements than normal since different readers can receive a different set of advertisements. Further, advertisers using the system and methods described herein will be able to target their ads much more precisely geographically, demographically and/or psycho-graphically that has been possible heretofore.

### CROSS-REFERENCE TO RELATED APPLICATIONS

This application is related to and claims the benefit of U.S. Provisional Application 61/188,639 filed on Aug. 11, 2008 and entitled, “System and Method for Advertising Goods and Services in Print Media”.

### FIELD OF THE INVENTION

The present invention relates generally to systems and methods for use in the advertising of goods and services in carrier delivered newspapers. More particularly, the present invention pertains to systems and methods that enable an advertiser to individually target desirable readers from within a much larger population of generic readers.

### BACKGROUND OF THE INVENTION

At its core, the advertising industry seeks to stimulate reader purchases of the products and/or services offered by its client advertisers. Among the many media available to, and used by, the advertising industry is print media. Print media used by the advertising industry includes, but is not limited to: newspapers, magazines, direct mailings, catalogs, marriage mail, and other print products that carry advertisements.

Display Advertising is one example of a type of print advertising, in which the ads are co-located with non-advertising content valued by readers. Readers' attention is drawn in by the non-advertising content which, in turn, results in the co-located advertising potentially being viewed by the reader. Newspapers are an example of print media which utilize Display Advertising. It is common for newspapers to consist of approximately 50% to 60% advertisements, with the remainder being editorial content (e.g. news, sports, entertainment, opinion, etc).

Advertisers tend to pay for the advertising offered by newspapers (or other print media) on a “cost-per-thousand” basis. A cost-per-thousand basis means the advertiser is charged a certain rate for each one thousand readers who receive their advertisement. Successful newspapers draw large audiences and then charge advertisers a proportionately large amount for access to that large audience of prospective buyers of the advertiser's goods and services. The model of advertising most commonly offered by newspapers is a one-size-fits-all advertisement. Using this model, an advertiser pays the newspaper for placing the same advertisement in every newspaper printed on that given day, or alternatively, in zones smaller than their entire circulation but still numbering in the thousands or tens of thousands.

Despite the historical success of newspapers using this model of advertising, in recent years the model has proven less and less attractive to advertisers. According to the Newspaper Association of America the newspaper industry's advertising revenue declined more than 9% from 2006 to 2007—the largest year-over-year drop on record. The first quarter of 2008 saw even steeper declines. As evidenced by these declines there are a number of significant limitations associated with the conventional newspaper advertising model.

For one, newspapers can only serve a limited number of ads each day. A typical newspaper, for example, may serve a market with 40,000 local businesses, but carry only 200 ads per day. That means that 99.5% of all local businesses in that market are not served by the newspaper on any given day. Newer advertising channels including Google suffer from no such constraint—they could theoretically serve 100% of advertisers each day. While they have not yet achieved that penetration, they undoubtedly serve a far greater percentage of businesses in each market than do local newspapers, with more businesses signing on each day as evidenced by their continued rapid revenue growth. If a newspaper were to serve a significantly larger number of local businesses each day than it currently does, it could only do so by making the size of each ad much smaller than is customary in today's market or by printing a much larger newspaper consisting of a higher percentage of ads. A higher advertisement-to-content ratio defeats the advertising model because a newspaper becomes less desirable to readers when there is comparatively less of what they value (i.e., content) and more of what they do not value (i.e., untargeted advertisements). Moreover, even the current number of 200 ads per day may be too many, as research has shown that very few advertisements are either relevant to any one particular reader or are remembered by a reader even just minutes after exposure to the advertisement.

A possible solution to the decline in newspaper advertising revenue (and circulation) is to print and deliver personalized or hyper-targeted newspapers that contain a unique or semi-unique set of ads (and unique or semi-unique content) for each person or for very small groups of readers. Some newspapers have moved incrementally towards increased targeting. For example a number of newspapers now print zoned editions of their newspapers (or zoned editions of supplements that are then inserted into the main, one-size-fits-all newspaper). Using this “zoned” approach, a newspaper with a circulation of 200,000 readers would print supplements for different geographic regions within their coverage area. Each region would consist of typically 10,000 to 20,000 or more readers—an improvement to the one-size-fits-all model, but still a far cry from personalization or hyper-targeting. An advertiser desiring to reach a given reader would typically have a very limited number of options: advertise in one of the paper's main sections (e.g. Front Section, Sports Section, Business Section, etc) and reach every reader, including the reader in question; or advertise in the zoned insert section that covers the geographic area in which the reader in question lives.

Even in the case of so-called “micro-zones,” the fundamental concept is the same: the newspaper has divided its region into a small number of fixed zones. The zones contain at best thousands but frequently tens of thousands of readers, and advertisers can elect to reach any zone in its entirety, or several zones in their entirety. Many of the readers in a given zone will often be poor candidates for a given advertisers goods or services, but the advertiser does not have the option to differentiate at any level below that of the several-thousand reader zone. This short-coming is significant because many advertisers have no need of reaching thousands or tens of thousands of readers, and even less those specific readers, and still less so in a product that contains hundreds of other highly irrelevant ads that have the effect of conditioning the reader to ignore such ads. Eye-tracking studies have confirmed the intuition that people simply fail to notice the vast majority of such ads.

The value of any particular reader to an advertiser depends on the likelihood of that reader becoming a customer of the advertiser. A reader is more or less likely to become a customer of any particular advertiser based on a number of factors including, inter alia, proximity to the advertiser, relevancy of the advertiser's product or service to the reader, visibility of what products or services the advertiser offers, and other more specific attributes of the reader that relate to the product or service offered by the advertiser. For example, a day-care center would value reaching a reader who was both nearby and who had young children much more highly than reaching a reader without children or one who lived far away. If the ad were large and colorful and one of only a small number of similarly relevant ads (and therefore would have the effect of conditioning the reader to notice rather than ignore those ads) it would be valued more highly still.

Existing newspaper advertising fails to serve an advertiser with regard to both geographic and demographic relevance, as well as the overall amount of attention the advertiser could reasonably expect an ad to generate from that target reader. Geographically, a newspaper's advertising zones are of fixed size and location, and so it is likely that the zone containing the advertiser's ad will either be too big or too small. The zone would also not be geographically situated to the advertiser's needs, but rather to those of the newspaper. For example, many advertisers will likely be located near the border of two or more of these zones, requiring that the advertiser forgo reaching likely readers in one or more of those zones, or resigning themselves to buy ad space in multiple zones, the majority of whose constituents are not within the advertiser's desired proximity. Furthermore, regardless of what decision the advertiser made about those geographic zones, it would be stuck advertising to every reader in the zone or zones, even those who were very unlikely to have children.

A further problem is that the minimum reach of newspaper advertising is typically much larger than many small businesses can afford. Because they deliver the same set of ads to, in some cases every reader, and in other cases to every reader in large zones of several thousand people, they have a limited inventory of space for ads each day. If every business in the newspaper's market were to advertise in the newspaper on the same day, the ads would have to either be so tiny as to be useless, or the newspaper would have to be many times thicker than it is today, with all of the growth in pages going to support advertising—a development unlikely to please many readers.

The only other option is for a separately printed piece to be inserted into the newspaper, or bagged alongside the newspaper in micro-zones. This process is both very expensive and very labor intensive with advertiser and newspaper together conspiring to manually select which regions to cover.

In short, contemporary newspapers have shown no ability, despite the obvious financial pressures affecting their industry, to offer advertisers access to individual readers or groups of readers that are smaller in number than the advertiser's desired reach who are both highly geographically and demographically or psycho-graphically matched to that advertiser's business. The idea that the hyper-targeted zones be significantly smaller in size than the advertiser's desired reach is an important one, as it enables the advertiser to construct his or her own “zone” by assembling the best-matching groups of readers, thereby resulting in a “zone” that is both optimally sized and optimally located, as well as targeted according to the advertiser's demographic and/or psychographic specifications.

The present disclosure describes a system and method for accomplishing this long sought after ability in a cost-effective and practical manner.

### SUMMARY OF THE INVENTION

The present disclosure addresses these and other shortcomings associated with conventional newspaper advertising models and systems by providing a method for producing hyper-targeted or fully personalized advertising for newspaper readers. The present disclosure describes a system, method and computer program product for producing hyper-targeted advertising for newspaper readers. A storage medium is remotely accessible over a computer network and stores information about the attributes of readers. A remote computer server communicable with the storage medium and also accessible over the computer network hosts and executes a web-based software application having a graphical user interface.

The web-based software application is a self-service on-line platform allowing advertisers to customize a list of readers with whom it wishes to advertise. The web-based software application presents to advertisers one or more reader attributes and allows an advertiser to select specific reader attributes and create a bounded geographic region or regions. This profile is stored and compared against a database of readers to determine matching readers. The advertiser can then select specific readers or small groups of readers from among those readers that best match the attribute parameters and reside within the specified geographic region or regions. These selections are also stored and a machine readable file that contains advertisements that have been targeted for the selected readers is created.

The remote computer server can then send the machine readable file to a variable data press that can produce a unique advertisement insert for each reader or small group of readers that contains a plurality of printed advertisements.

Another option allows the advertiser to select the dates on which to advertise to the selected readers wherein the machine readable file containing the advertisements that have been targeted for the selected readers will be created for use on the specified dates.

### BRIEF DESCRIPTION OF THE DRAWINGS

FIG. 1 is a block diagram illustrating a system environment.

FIG. 2 is a data flowchart for a process of generating print media advertisements for targeted readers.

FIGS. 3 and 4 are exemplary screen shots of a web-based data intake tool for building a reader target profile.

### DETAILED DESCRIPTION OF THE INVENTION

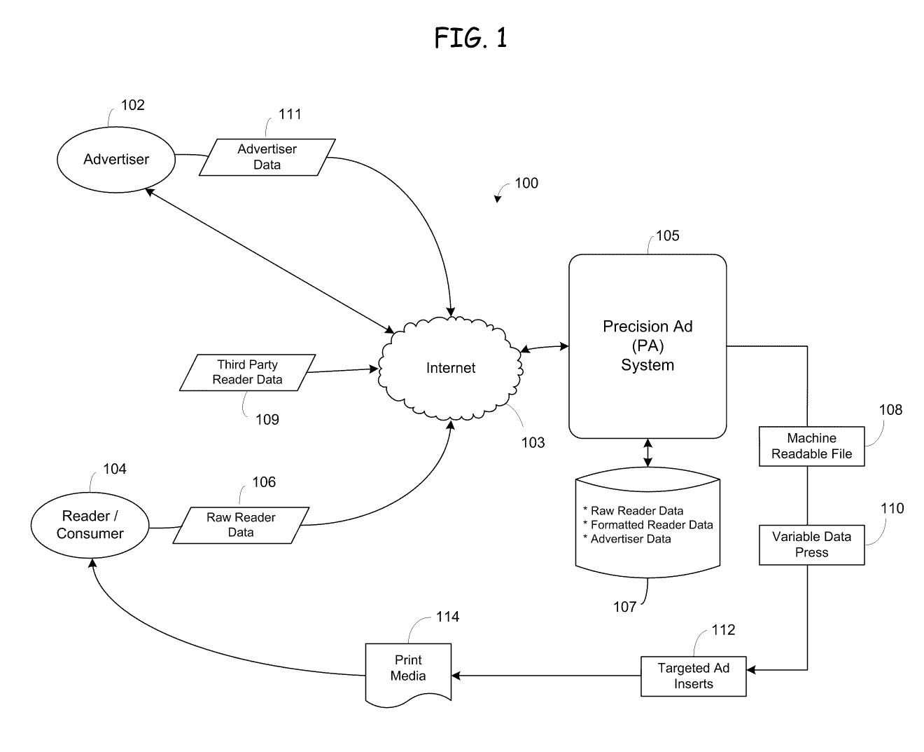

Referring now to FIG. 1, an exemplary system 100 for finding and targeting the most desirable readers for a given advertiser is illustrated. The exemplary system 100 utilizes data from advertisers 102 and readers 104. A computer based system referred to herein as a Precision Ad system or PA system 105 processes data pertaining to advertiser preferences and reader attributes and demographics.

The PA system 105 is generally a web-based software application resident on a remote computer server that is accessible to advertisers 102. Advertisers 102 access the application over a network connection such as, for instance, the Internet 103 and provide product, service and demographic data 111 about themselves in addition to building a target reader profile comprised of attributes of readers 104 with whom they intend to advertise. The advertiser information 111 can include, but is not limited to, name, address, telephone number, email address, website address, hours of operation, relevant purchase interest keywords (PIKs), products and services offered, images or other depictions of products and services offered, pricing information, product and service advertisements, reader-profile preferences, and a unique advertiser ID. The advertiser information 111 is received, processed and sorted by the PA system 105 and stored in a PA database 107.

The PA system 105 also obtains and stores reader data from a variety of sources. The raw reader data 106 can include, but is not limited to, name, address, telephone number, email address, products and services desired, filtering preferences (including, but not limited to, proximity, brand, and quality rating preferences), preferred method(s) of communication, communication frequency preference and a unique reader ID. The raw reader data 106 is processed and sorted by the PA system 105 into a more usable formatted state and also stored in the PA database 107.

In addition, legally available third party data 109 on readers 104, including but not limited to, data from newspapers on their readers, data from providers such as Claritas, Equifax and the like, and data from court records can be loaded into the PA system 105, formatted, and stored in the PA database 107.

The PA system 105 scans the PA database 107 for reader information and retrieves readers who match an advertiser's profile. This step is performed for each advertiser using the system. Advertisements which are deemed to be relevant to each reader or group of readers are then compiled into machine readable files 108 and that are input to variable data presses 110 so that targeted ad inserts 112 can be generated for specific readers or small groups of readers and distributed to the readers in their newspaper or other similar print media 114.

The exemplary system 100 includes one or more computer devices communicable with the PA system 105 via the Internet 103. The computer devices can include any of a variety of processing devices capable of displaying information and receiving input from an advertiser 102 and further capable of sending a representation of the input to the PA system 120. Examples of the computer devices can include, but are not limited to, a personal computer, a notebook computer, a networked personal digital assistant (PDA), a cellular phone, a two-way pager, and the like. In addition to or in conjunction with the Internet 103, the network can include a local area network (LAN), a wide area network (WAN), a metro area network (MAN), or a combination thereof. A variety of network mediums can be implemented, such as wire-based networks, fiber-optic networks, wireless networks, and the like.

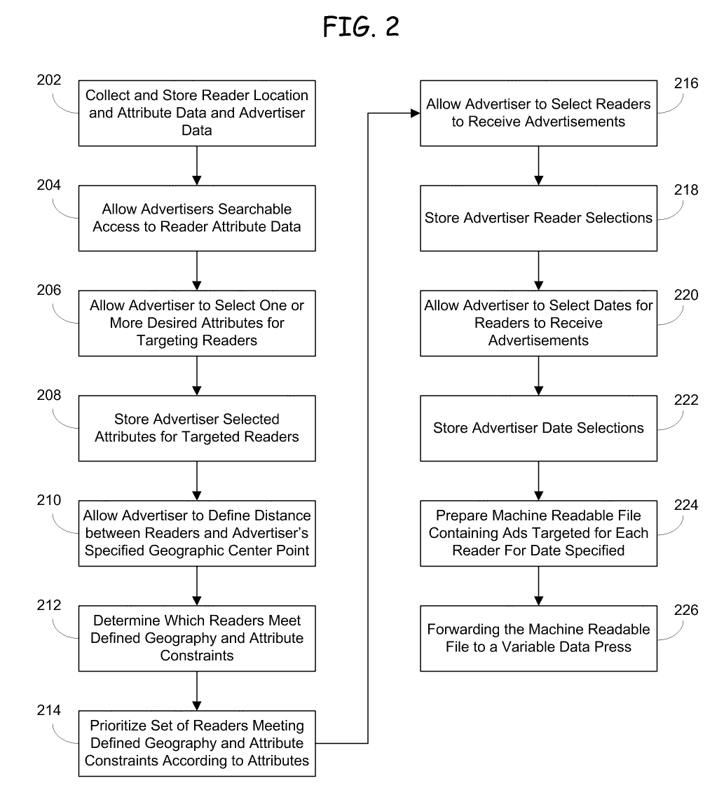

FIG. 2 is a data flowchart for a process of generating print media advertisements for targeted readers. A web-based software application resident on a server computer collects and processes information from advertisers and about readers in order to match a desired advertiser profile with readers having attributes that match the profile. The application then creates a machine readable file for each reader or a relatively small group of readers that contains ads targeted specifically for them. Collectively the application and server are referred to as the Precision Ad or PA system.

Reader attribute and location data is collected and stored by the PA system 202. The data collected includes attributes of readers gleaned from various sources including, but not limited to, Claritas, newspaper or magazine subscription data, court and/or other municipal data, and other publicly available databases or from readers themselves.

Claritas compiles from various sources profiles of households throughout the United States. These profiles include data such as the likelihood that a given household owns their home, is married, has children, and so forth. Sometimes this data is explicitly indicated, and in other cases in might be indirectly indicated by the assignment of the household to one of a finite number of household categories, with the category being defined by the various probabilities of home ownership, marital status, children present, and other such attributes as the data provider might anticipate being useful to its clients.

Magazine and newspaper subscription data can indicate something useful to an advertiser about the reader in question. A reader who is known to subscribe to a magazine on golf, for instance, is likely to be a golfer, and therefore may be the kind of reader that a golf related advertiser would consider desirable.

Court or municipal records often contain information about readers or their homes or other information. For example, a city assessor's office may have publicly available information on the size of each house in the municipality and when it was built. Houses over ten (10) years old may be attractive to home remodeling advertisers, or HVAC service providers since 10 year old houses are more likely to be in need of such services than newer houses.

Advertisers themselves may be in possession of databases of readers. Such information whether purchased from a list vendor or generated by the advertiser itself, may indicate a reason to advertise to, or perhaps a reason not to advertise to certain readers.

Readers themselves may, if given a suitable interface, indicate the products and services that are of particular interest to them, and these stated preferences may be of interest to advertisers who provide the goods or services in question.

Advertiser information is also collected and stored pertaining to the attributes they use to identify their potential customers.

The PA System allows advertisers searchable access to its database of readers and reader attributes 204. Access is generally via a web-based browser into a graphical user interface of the PA system software application. The PA system displays reader attributes to advertisers. These attributes may include, but are not limited, the reader's marital status, whether or not he or she owns their home or rents, the annual household income, and so forth. The advertiser is then permitted to select which reader attributes they desire readers possess so that an ad can be specifically targeted to them 206. The advertiser selections are then stored by the PA system 208.

The PA system then prompts the advertiser to select one or more geographic areas of interest 210, the size of each being set by the advertiser. For example, one advertiser may want to advertise to home-owners within 1 mile of their business, while another may want to advertise to home-owners with 8 miles. Another (or the same) advertiser may want to target a specific neighborhood which they believe contains readers likely to be interested in their service or product. For instance, a landscaper may wish to target homes near a current client to expand that market or the landscaper may wish to focus on a neighborhood of higher income homes regardless of its distance from his place of business. The PA system then processes the advertiser's targeted reader profile of attributes and geographic boundary or boundaries against the database of stored reader data to determine which readers meet the advertiser defined attribute and geography parameters 212.

The PA system then prioritizes all geographically qualified readers or groups of readers 214. Some matches may be better suited to the advertiser profile than others since the profile can weight or favor some attributes as being more or less important than others. For instance, distance can be the highest weighted attribute and a reader within one mile of the advertiser may be considered more desirable than a reader within 10 miles even if the overall distance parameter allows for a 10 mile distance between reader and advertiser. In another example, household income may be considered the most important attribute to a upscale luxury car advertiser.

The advertiser can then select which readers or groups of readers it would like to advertise to using the prioritized list 216. The advertiser's selections are then stored by the PA system 218. The advertiser is also prompted to select date(s) that the advertisements are to be sent to the reader 220. The date information is also stored by the PA system 222.

On or shortly before the date which the advertisements will be presented to readers the PA system prepares a machine readable file that contains all the advertisements that have been targeted for that reader or group of readers for that specific day 224.

The machine readable files are then input to a variable data press 226 (e.g., a Xerox iGen3™ or Oce JetStream™ press) which is capable of producing the many different printed advertising products needed to provide each reader or group of readers with the correct set of matching ads.

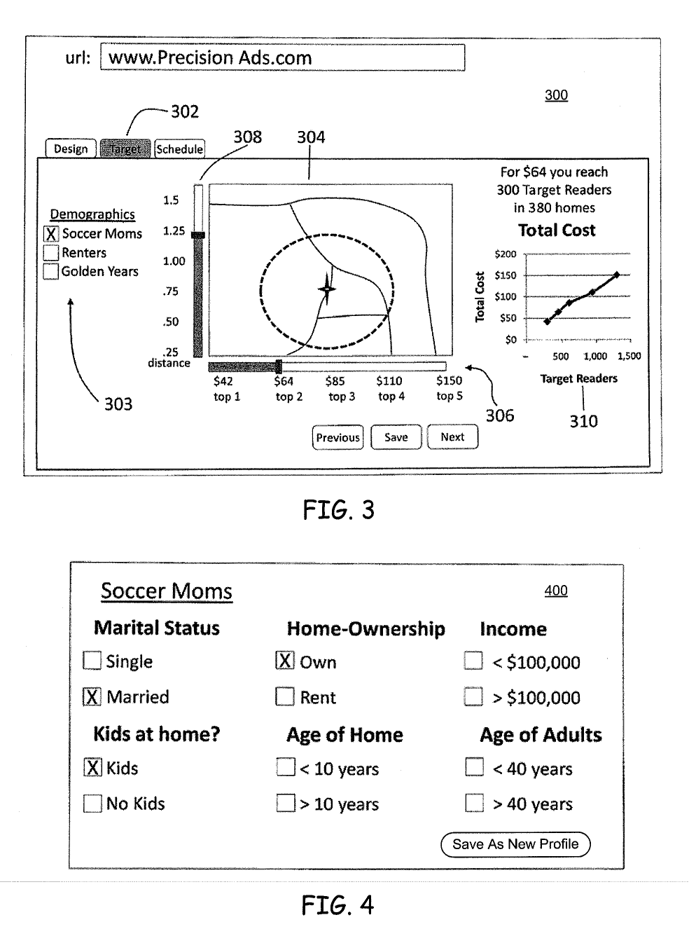

FIGS. 3 and 4 are exemplary screen shots of a web-based data intake tool for building a reader target profile.

The PA system 105 is provides a website comprising one or more web pages for use by advertisers 102 to input product search terms, reader-profile preferences, details about products and services, images representing the products or services, selected offers, information about place(s) of business and operating hours, and the like. The term “reader-profile preferences,” as used herein, refers to one or more advertiser-identified criteria which delineate for the PA system 105 which readers should receive advertisements from an advertiser and, of those that do receive advertisements, which offers the advertisements should include. Such reader-profile preferences can be inclusive or exclusive and can include, but are not limited to, geographic location, marital status, household income, presence or absence of children, subscription to certain publications that indicate certain of the reader's interests (e.g. subscription to golf magazine could indicate to a retailer of sporting goods the reader's interest in golfing) and the like.

The term “website,” as used herein, refers to a grouping of one or more web pages navigable by a web browser or other interface capable of networked communication. The term “web page” as used herein, refers to a graphical user interface (GUI) adapted for display on the web browser, and further being adapted to receive input from an advertiser 102 and to transmit the advertiser's information to the PA system 105 to be stored in the PA database 107. The web pages can include web pages for system administration, for displaying information, for receiving information, and the like, and are representations of data from the PA System 105.

For instance, FIG. 3 is a web-based screen shot 300 of a data intake tool for building a reader target profile. A “Target” tab 302 is highlighted indicating the function of the current screen. The left side of the screen 303 includes various attributes of readers that can be selected. In this example, the advertiser has selected attributes of “soccer mom”, “golden years”, and “high income”. Each of those attributes is defined by parameters. Golden years may be defined as over 50 years of age while high income may be defined as at least $100,000 of annual income.

A localized map 304 occupies the center of the screen. The localized map is centered about the advertiser's desired geographic target area and includes an icon and link that can each be used to change the target geographic area.

The screen illustrates a controllable input interface 308 that allows the advertiser to define the size of the geographic area of interest and another 306 that allows the advertiser to define the number of readers to whom it wants to advertise. For instance, the advertiser can drag the push pin that defines the center of the map to a new ‘center’ location from which to create a geographic boundary. Fixing the center location can either be achieved by dragging and dropping or entering a specific address into a text box.

The right side of the screen 310 provides total cost information (in graphical form in this example) based on the number of target readers within the attribute/geography parameters previously defined.

FIG. 4 is a web-based screen shot 400 of a data intake tool for building a reader target profile specifically for “Soccer Moms”. It is shown in the form of a pop-up screen initiated from the general data intake screen of FIG. 3. An advertiser can refine their own definition of a soccer mom based on categories such as marital status, number of kids, age of adults, home ownership, type of home, age of home, and household income. Similar screen shots can exist for other generic profiles such as “Yuppie” or “Retiree”, etc. . . . .

The result of the system and method described above is a very different kind of print media advertising than has been historically available in the carrier delivered newspaper industry. It is different in several aspects.

The minimum audience size that an advertiser must buy is as small as one reader with an improved distribution system, or approximately 30-200 readers with no change to the newspaper's distribution system. This is an order of magnitude smaller than any metro newspaper offers today.

The geographic area that an advertiser's ad will reach has its size defined by the advertiser, not by preexisting fixed newspaper zones, and has as its center-point the advertiser's location, or any other point chosen by the advertiser.

Within that geographic area of interest the advertiser has the freedom to select those readers or groups of readers who most closely match the attributes that would qualify them as likely customers.

This matching of readers to advertisers is done in a highly automated manner, with no need for human intervention other than the advertiser himself selecting the attributes of interest and the geographic area of interest.

The resulting advertising products are highly variable—that set of ads delivered to House A is different than those delivered to House B.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

To the extent that the present invention is described with reference to flowchart illustrations and/or block diagrams of methods, apparatus (systems) and computer program products according to embodiments of the invention, it will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of a computer, portable computer, mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for producing hyper-targeted advertising for newspaper readers comprising:
(a) storing information about the attributes of readers on a storage medium remotely accessible over a computer network;
(b) presenting to advertisers one or more reader attributes using a web-based software application executing on a remote computer server accessible over the computer network wherein the remote computer server is communicable with the storage medium;
(c) allowing advertisers to select specific reader attributes via a graphical user interface for manipulating the web-based software application;
(d) allowing advertisers to create at least one bounded geographic region via the graphical user interface;
(e) storing the advertiser specified reader attributes and at least one geographic region on the storage medium;
(f) determining which readers match the attribute parameters and reside within the at least one specified geographic region;
(g) allowing advertisers to select specific readers from among those readers that match the attribute parameters and reside within the at least one specified geographic region via the graphical user interface;
(h) storing, in the storage medium, the readers selected by the advertiser via the graphical user interface; and
(i) creating a machine readable file that contains advertisements that have been targeted for the selected readers.

2. The method of claim 1 further comprising sending the machine readable file to a variable data press that can produce an insert for each reader that contains a plurality of printed advertising products.

3. The method of claim 1 further comprising allowing advertisers to select the dates on which to advertise to the selected readers wherein the machine readable file containing the advertisements that have been targeted for the selected readers will be created for use on the specified dates.

4. The method of claim 1 wherein the reader attributes include one or more of marital status, home ownership status, income data, number of children, and age of home.

5. A computer readable medium storing a computer program product for producing hyper-targeted advertising for newspaper readers, the computer readable medium comprising:
computer program code for storing information about the attributes of readers;
computer program code for presenting one or more reader attributes using a web-based software application executing on a remote computer server accessible over the computer network wherein the remote computer server is communicable with the storage medium;
computer program code for allowing selection of specific reader attributes via a graphical user interface for manipulating the web-based software application;
computer program code for allowing creation of at least one bounded geographic region via the graphical user interface;
computer program code for storing the specified reader attributes and geographic region on the storage medium;
computer program code for determining which readers match the attribute parameters and reside within the at least one specified geographic region;
computer program code for allowing selection of specific readers or small groups of readers from among those readers that best match the attribute parameters and reside within the at least one specified geographic region via the graphical user interface;
computer program code for storing, in the storage medium, the readers selected via the graphical user interface; and
computer program code for creating a machine readable file that contains advertisements that have been targeted for the selected readers.

6. The computer readable medium of claim 5 further comprising computer program code for sending the machine readable file to a variable data press that can produce an insert for each reader that contains a plurality of printed advertising products.

7. The computer readable medium of claim 1 further comprising computer program code for allowing selection of the dates on which to advertise to the selected readers wherein the machine readable file containing the advertisements that have been targeted for the selected readers will be created for use on the specified dates.

8. The computer readable medium of claim 1 wherein the reader attributes include one or more of marital status, home ownership status, income data, number of children, and age of home.

9. A system for producing hyper-targeted advertising for newspaper readers comprising:
a storage medium remotely accessible over a computer network for storing information about the attributes of readers;
a remote computer server accessible over the computer network wherein the remote computer server hosts and executes a web-based software application having a graphical user interface for manipulating the web-based software application and is communicable with the storage medium for:
presenting to advertisers one or more reader attributes;
allowing an advertiser to select specific reader attributes using the graphical user interface;
allowing advertisers to create at least one bounded geographic region;
storing the advertiser specified reader attributes and at least one geographic region on the storage medium;
determining which readers match the attribute parameters and reside within the at least one specified geographic region;
allowing advertisers to select specific readers from among those readers that match the attribute parameters and reside within the at least one specified geographic region;
storing, in the storage medium, the readers selected by the advertiser; and
creating a machine readable file that contains advertisements that have been targeted for the selected readers.

10. The system of claim 9 wherein the remote computer server further sends the machine readable file to a variable data press that can produce an insert for each reader that contains a plurality of printed advertising products.

11. The system of claim 9 wherein the remote computer server further allows advertisers to select the dates on which to advertise to the selected readers wherein the machine readable file containing the advertisements that have been targeted for the selected readers will be created for use on the specified dates.

12. The system of claim 9 wherein the reader attributes include one or more of marital status, home ownership status, income data, number of children, and age of home.
